(19) United States
(12) Patent Application Publication
(10) Pub. No.: US 2012/0253920 A1
(43) Pub. Date: Oct. 4, 2012

(54) SYSTEM AND METHOD FOR VIEWERSHIP VALIDATION BASED ON CROSS-DEVICE CONTEXTUAL INPUTS

(76) Inventors: Mark D. Yarvis, Portland, OR (US); Sharad K. Garg, Portland, OR (US)

(21) Appl. No.: 13/078,565

(22) Filed: Apr. 1, 2011

(51) Int. Cl. G06Q 30/00

(52) U.S. Cl. 705/14.41

(57) ABSTRACT

Systems and methods to identify a viewer's reactions to an advertisement. A viewer's personal computing platforms (e.g., personal computer, cell phone, etc.), for example, may be utilized to identify user actions. Actions identified through such devices may validate that an advertisement was viewed and acted upon. After an advertisement is presented, the viewer may take any of several actions. A viewer may browse for the advertised product, either online or in a physical store. The viewer may ultimately purchase the advertised product. The user may share information about the product with friends. The reaction of the viewer may be monitored, by capturing context data associated with activity performed using the viewer's personal computing platforms for example. This data may then be correlated with metadata regarding the advertisement. If it is determined that the viewer investigated or purchased the product within a predefined time after being exposed to the advertisement, then this fact may be tallied anonymously. The number of such matches across a set of viewers may be recorded and reported to an audience measurement service. In an embodiment, such data may be sold to an advertiser.

### BACKGROUND

Every year, advertisers spend billions of dollars on television advertising. Many of these commercials, however, are not watched. Viewers may change channels or step away from the television. Of the viewers who actually watch a commercial, it may be difficult to determine how many viewers have a positive reaction to the subject of the advertisement. From the perspective of the advertisers, it may be unclear whether a viewer who watches a commercial is actually persuaded to investigate or purchase the product or service being advertised. The following questions arise: Given the amount of money spent on television advertising, how much benefit is gained? For a given commercial, how many viewers see it, and how do they react? How many viewers actually investigate a product? How many viewers actually purchase the product? Given the considerable cost of airing a television commercial, how much benefit (i.e., sales) is actually gained? Might a product have greater sales if its commercial were shown on a different television network, or at a different time, or in the context of a different program?

These questions could be answered, at least in part, if it could be determined how many potential viewers of a commercial, shown at a particular time on a particular channel, become interested enough to investigate or purchase the advertised product. This is a particularly difficult question when compared to internet advertising, for example. Here, the number of people who visit a given website may be measured, and the number who click on an advertisement may be counted. In the world outside of web purchasing, however, human behavior is not as easily tracked. Moreover, if statistics could be compiled that address the questions above, such information would be of great value to advertisers, especially given the amount of resources required to produce television advertisements.

### BRIEF DESCRIPTION OF THE DRAWINGS/FIGURES

FIG. 1 is a flowchart illustrating the processing of an embodiment.

FIG. 2 is a flowchart illustrating presentation of an advertisement, according to an embodiment.

FIG. 3 is a flowchart illustrating a matching process, according to an embodiment.

FIG. 4 is a block diagram illustrating the system described herein, where matching takes place at viewer's personal computing platform, according to an embodiment.

FIG. 5 is a block diagram illustrating the system described herein, where matching takes place at a media platform, according to an embodiment.

FIG. 6 is a block diagram illustrating a software or firmware embodiment.

### DETAILED DESCRIPTION

An embodiment is now described with reference to the figures, where like reference numbers indicate identical or functionally similar elements. Also in the figures, the leftmost digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

The systems and methods described herein may identify the viewer's reactions to an advertisement. A viewer's personal computing platforms (e.g., personal computer, cell phone, etc.) may be utilized to accomplish this. Actions identified through such devices may validate that an advertisement was viewed and acted upon. After an advertisement is presented, the viewer may take any of several actions. A viewer may browse for the advertised product, either online or in a physical store. The viewer may ultimately purchase the advertised product. The reaction of the viewer may be monitored, by capturing context data associated with activity performed using the viewer's personal computing platforms for example. This data may then be correlated with metadata regarding the advertisement. If it is determined that the viewer investigated or purchased the product within a predefined time after being exposed to the advertisement, then this fact may be tallied anonymously. The number of such matches across a set of viewers may be recorded and reported to an audience measurement service. In an embodiment, such data may be sold to an advertiser.

Note that while the advertisement may concern a product or service, the subject of the advertisement is denoted generically herein as a product, a term which may be interpreted to encompass both a product and a service.

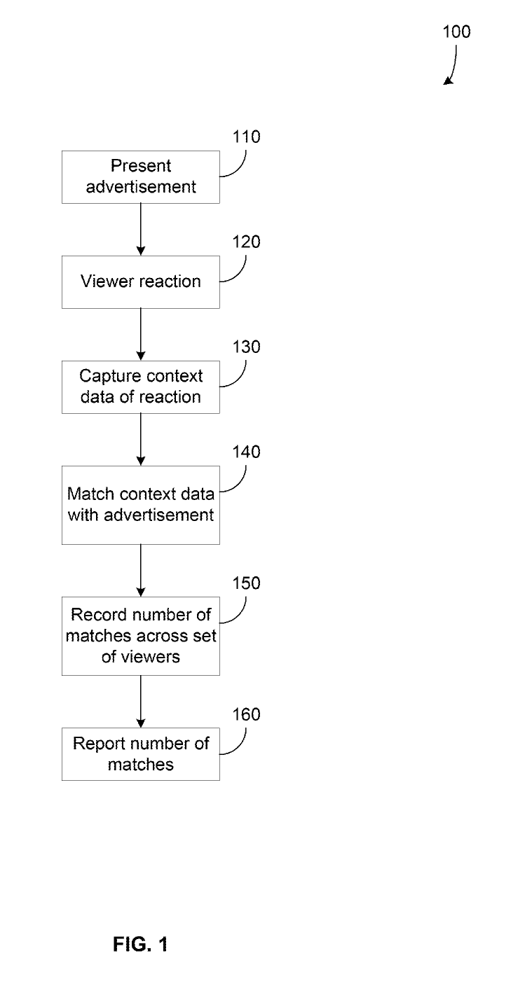

FIG. 1 illustrates the overall processing of the system described herein, according to an embodiment. At 110, an advertisement may be presented to a viewer. Typically, the advertisement may be presented in conjunction with content, e.g., as a commercial in the context of a television program. In an embodiment, the advertisement may be inserted into the content by a broadcaster or other content provider; alternatively, the advertisement may be stored at the viewer's media platform (such as a set-top box (STB)) and inserted into the content locally. Note that the advertisement may have associated metadata. This may include, for example, metadata describing the time of the presentation of the advertisement, the identity of the product or service being advertised, other information about the product or service, and the company selling the product or service. This metadata may be recorded in a history database or other data structure that is local to the viewer.

At 120, the viewer may react to the advertisement. The reaction may take any of several forms. The viewer may choose to investigate the product further, perhaps by browsing or researching the product online (e.g., visiting the manufacturer's website or a retailer's website, or searching for reviews of the product), or by doing so in person in a physical retail store. Online browsing may be initiated by keyword search or by scanning a barcode in an advertisement using a digital camera, as is sometimes done in print advertising. Also, the viewer may take the above described actions using a personal computing/communications device such as a mobile information device (MID), cell phone, laptop or tablet computer. The viewer may also react by actually purchasing the product, again, either online or in person. If the viewer is at a physical retail location, the viewer's reaction may be the scanning of a bar code on the product, using the viewer's smart phone. The reaction may also be a purchase at the physical retail location. Also, the viewer may react by telling someone else about the product, perhaps via email, text message, or instant messenger.

At 130, this reaction may be captured in ways that will be described in greater detail below. Generally, this capture may include recording online activity that the viewer performs through his STB, personal computer, laptop, tablet computer, or smart phone, for example. This may include the capture of uniform resource locators (URLs) or search terms, or by interpreting the contents of a viewed web page, for example. In an embodiment, physical presence at a retail location that sells the product may be determined by capturing global positioning (GPS) coordinates of a personal computing platform carried by the viewer. These coordinates may then be associated with a street address and a business at that address, using publicly available information. Such a personal computing platform may be a smart phone or tablet computer, for example. If the viewer is at a physical retail location and the viewer scans the bar code on the product using the viewer's smart phone, the identity of the scanned product may be captured. Data that describes a reaction, its location, and/or the time at which the reaction occurs may be referred to as context data of the reaction.

At 140, the context data of the reaction may be compared and matched with the advertisement and the metadata of the ad, to determine whether the viewer may have reacted in response to the advertisement. If, for example, the viewer is shown an advertisement for a product, and the viewer then searches for and purchases the product online shortly after being shown the advertisement, then this may be observed as a match between the advertisement's metadata and the context data to the viewer's reaction. In another example, if the viewer visits a physical location corresponding to a retailer that sells the advertised product, the context data of such a visit (e.g., the location and time of the visit) may be matched with the metadata of the advertisement.

In an embodiment, a match may require that the reaction take place within a certain amount of time after the advertisement was viewed. Otherwise, the viewer's action may not have been a reaction to the advertisement. In an embodiment, the amount of time within which the viewer's action may be considered to be a reaction to the ad may vary according to the context. An online reaction (e.g., researching a product) may have to happen within a certain period, such as one day, for example, in order to be considered a reaction. A physical action (e.g., visiting a store) may be given a longer period (e.g., one week) in which to take place, in order to be considered a reaction. Moreover, the cost of the product may also be a consideration, since the purchase of a more expensive item may be expected to require more thought. For an inexpensive item, such as an item of clothing, a viewer's action may have to occur within a day of viewing an advertisement in order to be considered a reaction, for example; the action may have to occur within a week for a more expensive item, for example, such as PC or television. Note that these time intervals are presented here as examples only, are not intended to limit the scope of the description.

At 150, the number of matches for this showing of the advertisement may be tallied across a set of viewers. Note that in an embodiment, this information may not include any identification of particular viewers. Only the number of matches may be saved. At 160, this number may be reported anonymously to an audience measurement service. Alternatively or in addition, a third party anonymization service may be used to preserve the anonymity of individual viewers. In an embodiment, public key protocols may be used in communication with such a service to assure anonymity. In an embodiment, this information (i.e., the number of matches) may be sold by the audience measurement service to the advertiser, to the broadcaster, or to any other interested parties.

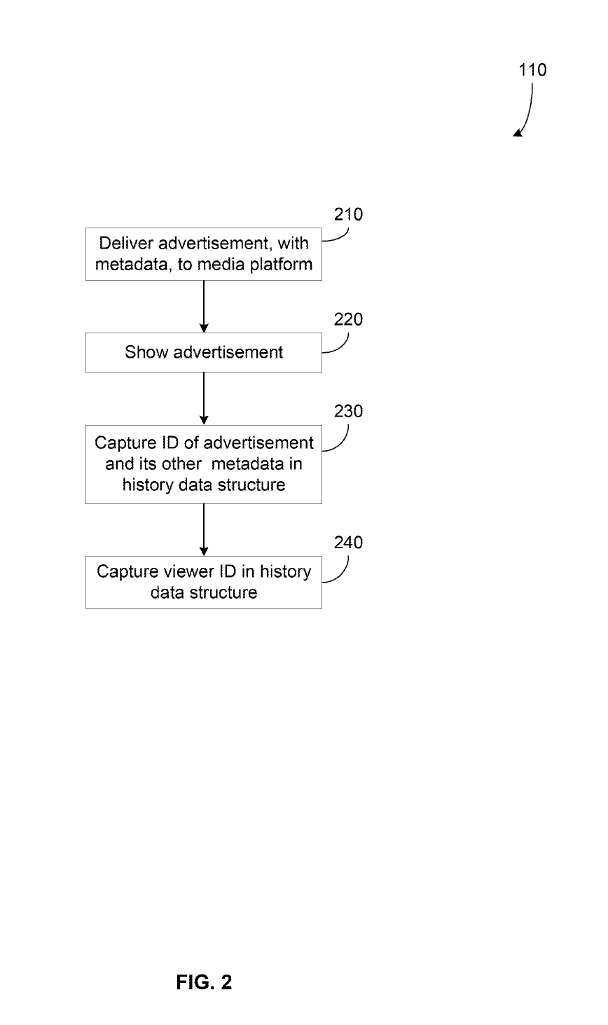

The presentation of the advertisement to the viewer is illustrated in greater detail in FIG. 2, according to an embodiment. At 210, the advertisement may be delivered, along with its metadata, to the media platform of the viewer. As noted above, when delivered, the advertisement may already be incorporated into content; alternatively, the advertisement may be delivered separately and subsequently inserted into content at the viewer's media platform. At 220, the advertisement is shown. At 230 the metadata of the advertisement may be captured in a data structure local to the viewer. In an embodiment, the data structure (referred to herein as the history data structure) may be housed in the media platform (e.g., STB) of the viewer; alternatively, the history data structure may be stored in a separate computing platform used by the viewer, such as a PC, laptop, or smart phone. The metadata of the advertisement may include an identifier (ID) for the advertisement, a description or name of the product, and the time at which the advertisement was shown, for example.

At 240, an identifier of the viewer is also captured in the history data structure. This identifier may be determined by determining the owner of the user profile currently in use at the media platform, for example. Alternatively, this identifier may be determined by determining the owner of a cell phone or other personal computing platform that is found to be in proximity to the media platform. Alternatively, biometric means may be used in a remote control or STB to determine the identity of the viewer. Accelerometers in the remote may be used to sense how the remote is physically handled, where readings may compared to a stored profile of the viewer, for example. Biometric means may alternatively include recognition of the viewer's voice using a microphone and a stored profile of the voice, or recognition of the viewer's face using a camera and a stored image. These alternatives are presented as examples, and are not intended to be limiting. As would be understood by the person of ordinary skill in the art, additional mechanisms may be used to determine the identity of the viewer.

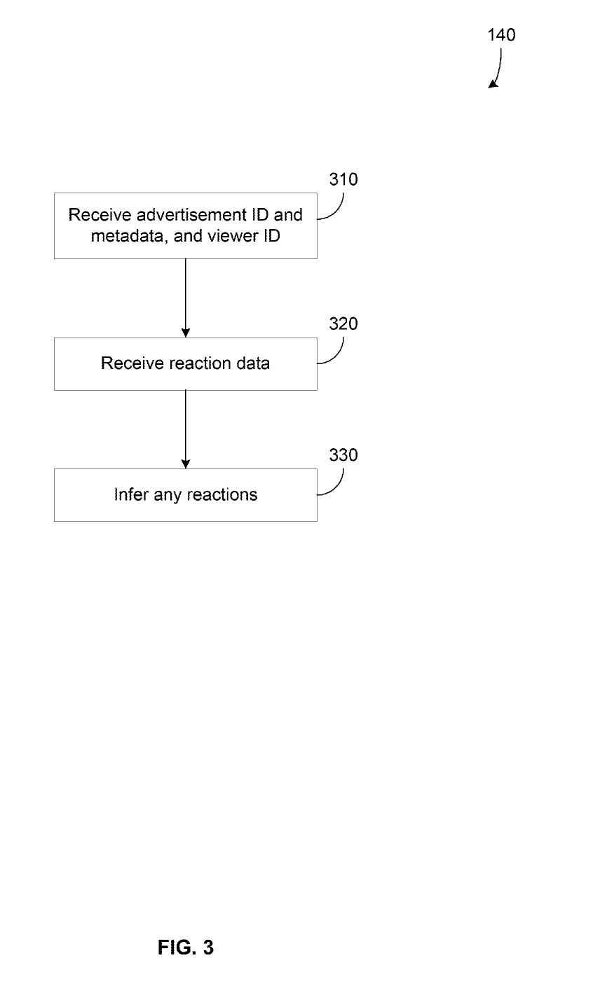

The matching performed at 140 is illustrated in greater detail in FIG. 3, according to an embodiment. At 310, the ID and other metadata of the advertisement and the ID of the viewer may be received by logic that is to perform the matching process. At 320, the context data of the viewer's reaction may be received. At 330, the data received at 310 and 320 may be correlated, to infer whether the viewer's actions may have been a reaction to the advertisement.

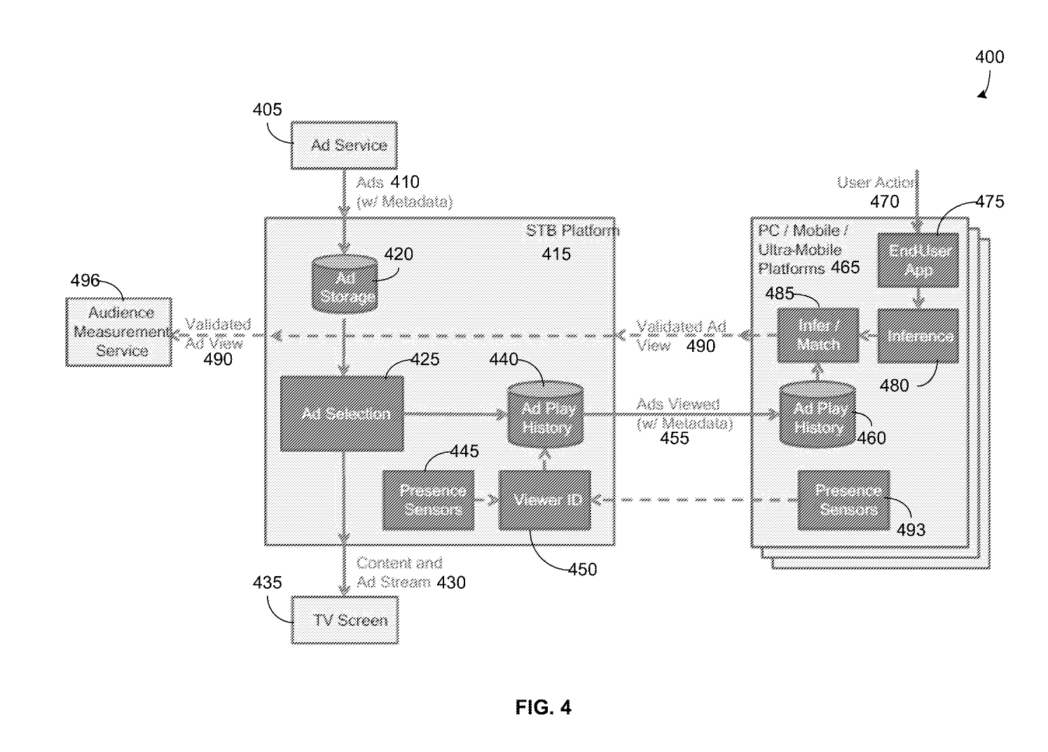

FIG. 4 illustrates a system that may perform these operations, according to an embodiment. An advertising service 405 may provide one or more advertisements 410, including metadata for the each advertisement, to a media platform such as STB 415. In the illustrated embodiment, the advertisements may be stored at an ad storage device 420 in STB 415. Ad storage device 420 may be a hard disk, a flash memory, or any other non-volatile memory device. An advertisement selection module 425 may be responsible for selection of a particular advertisement for insertion into content. This may result in content and ad stream 430, which may be eventually displayed to the viewer through a display, such as TV screen 435. When the selected advertisement is played for the viewer, the metadata related to the advertisement may be stored at a history data structure, shown here as ad play history 440. Ad play history 440 may be stored in any type of non-volatile memory device, such as a hard disk or flash memory. In an embodiment, ad play history 440 may be stored on the same device as ad storage 420.

In the embodiment shown in FIG. 4, the advertisement may be sent to the STB 415, where it may be combined with a content stream. In such an embodiment, the ad selection logic 425 may choose the advertisement in a manner tailored specifically to the viewer, according to known interests of the viewer, for example. In an alternative embodiment, the advertisement may be combined with content before delivery to the STB 415, the entire stream may be shown to the viewer, and the related metadata of the advertisement may be saved to ad play history 440.

Ad play history 440 may also store identification information for the viewer, shown here as viewer ID 450. This information may identify who, specifically, is viewing the advertisement. With viewer ID 450, it may then be possible to determine the behavior of this viewer, i.e., whether and how he reacts to the advertisement. Viewer ID 450 may be determined in any of several ways, as discussed above. In the illustrated embodiment, one or more presence sensors 445 are shown, which are able to determine viewer ID 450 through biometric means, for example. Such biometric means may be used in a remote control or the set top box 415. Accelerometers in the remote may be used to sense how the remote is physically handled, where readings may compared to a stored profile of the viewer, for example. Biometric means may alternatively include recognition of the viewer's voice using a microphone and a stored profile of the voice, or recognition of the viewer's face or body shape using a camera and a stored image. Alternatively, if the viewer is logged in to STB 415 in order to access his particular preferences or profile, this may be used to determine viewer ID 450. Alternatively, one or more presence sensors 493 in the viewer's computing platform 465, may provide viewer ID 450. Presence sensor 493 may also use biometric technology, a current user profile, or other means to identify the user of platform 465. In this case, viewer ID 450 may be transferred to STB 415 through a wired or wireless data link, using any protocol or networking technology known to persons or ordinary skill in the art.

In the illustrated embodiment, information from ad play history 440 may be shared with one or more of the viewer's computing platforms 465. Such a platform 465 may be, for example, a PC, a laptop, a tablet computer, or a smart phone. The information transferred to the viewer's computing platform(s) 465 is shown as metadata 455, and may be stored at a memory device as ad play history 460. As in the case of ad play history 440, this memory device in platform 465 may be any type of non-volatile memory device, such as a hard disk or flash memory. Metadata 455 may include the identifier for a viewed advertisement, the metadata associated with this advertisement, and the viewer ID 450. This transfer of metadata 455 may take place through a wired or wireless connection, using any type of data communications network/link/protocol known to one or ordinary skill in the art.

A user action 470 may then be received at the viewer's computing platform(s) 465, and may represent the viewer's reaction to the advertisement. The action 470 may be, for example, browsing on the internet, surfing to a particular site, performing a search, or making an on-line purchase. Action 470 may be a physical visit to a store that sells the product. If the viewer is present in such a store, action 470 may include the scanning, by the viewer, of a bar code of the product's label using the viewer's smart phone. The action 470 may alternatively be telling someone else about the advertised product, through email, text message, or instant messenger (IM) for example.

The action 470 may be captured by an end-user application 475. Based on the action 470, information may be generated by application 475, and input to potential inference module 480. Potential inference module 480 may extract context data of the user action 470, and may generate a digital codified description of action 470. Context data may be, for example and without limitation, a web address accessed by the viewer, or any search terms employed (e.g., product or company name), as captured by application 475. Captured context data may be the address or name of a physical retail store, resulting from a capture of GPS coordinates from a personal communications device, such as a smart phone, or the bar code scanned by the viewer using the phone. Any such information may be captured or derived by application 475. Context data may also be key words used in a text message, email, or IM sent to another person, as captured by application 475.

The context data from the potential inference module 480 and metadata 455 from ad play history 460 may then be sent to inference/matching module 485. Inference/matching module 485 may then determine if there is a correlation between the metadata 455 and the context data from potential inference module 480. The match criteria may include whether the action 470 was directed towards a product that was the subject of the viewed advertisement, where the product was identified in metadata 455. As noted above, an action 470 that may meet this criterion may include an internet search for the product name, a visit to the product's web site or to a retailer site that sells this product, or an on-line purchase of this product, for example. An additional criterion may be that the action 470 had to have happened within a predefined period after viewing the advertisement. Recall that the metadata 455 may include the time of presentation; likewise the context data (from potential inference module 480) may include the time at which action 470 took place. If the action 470 took place long after the presentation of the advertisement, then the action 470 may not be considered to be a reaction to the advertisement. In an embodiment, the amount of time within which the viewer's action may be considered to be a reaction to the ad may vary according to the context. As described above, an online reaction (e.g., researching a product) may have to happen within a certain period, such as one day, for example, in order to be considered a reaction. A physical action (e.g., visiting a store) may be given a longer period (e.g., one week) in which to take place, in order to be considered a reaction. Moreover, the cost of the product may also be a consideration, since the purchase of a more expensive item may be expected to require more thought. For an inexpensive item, a viewer's action may have to occur within a day of viewing an advertisement in order to be considered a reaction; the action may have to occur within a week for a more expensive item. Note that these time intervals are presented here as examples only, are not intended to limit the scope of the description.

Note that user action 470 may not be an on-line action. The viewer may instead respond to a product advertisement by physically visiting a brick-and-mortar store that sells the product. User action 470 may be such a visit. One way in which such an action may be detected is by taking advantage of the GPS capabilities of the viewer's smart phone. The smart phone (which may be construed as viewer computing platform 465) may detect that it is entering a location that corresponds to a retailer for the advertised product. The end-user application 475 may then receive an indication of this and generate the input to potential inference module 480.

The inference/matching module 485 may be embodied in hardware, firmware, software, or any combination thereof.

If a match is found by inference/matching module 485, then the viewing of the advertisement is considered validated. A message 490 reflecting this validation may then be sent anonymously to an audience measuring service 496. A third party anonymization service may be used to preserve the anonymity of individual viewers. In an embodiment, public key protocols may be used in communication with such an anonymization service to assure anonymity. Audience measuring service 496 may tally the number of validations received for the advertisement across a set of viewers, resulting in a final count. In an embodiment, this count may be sold or otherwise offered to the advertiser that produced the ad.

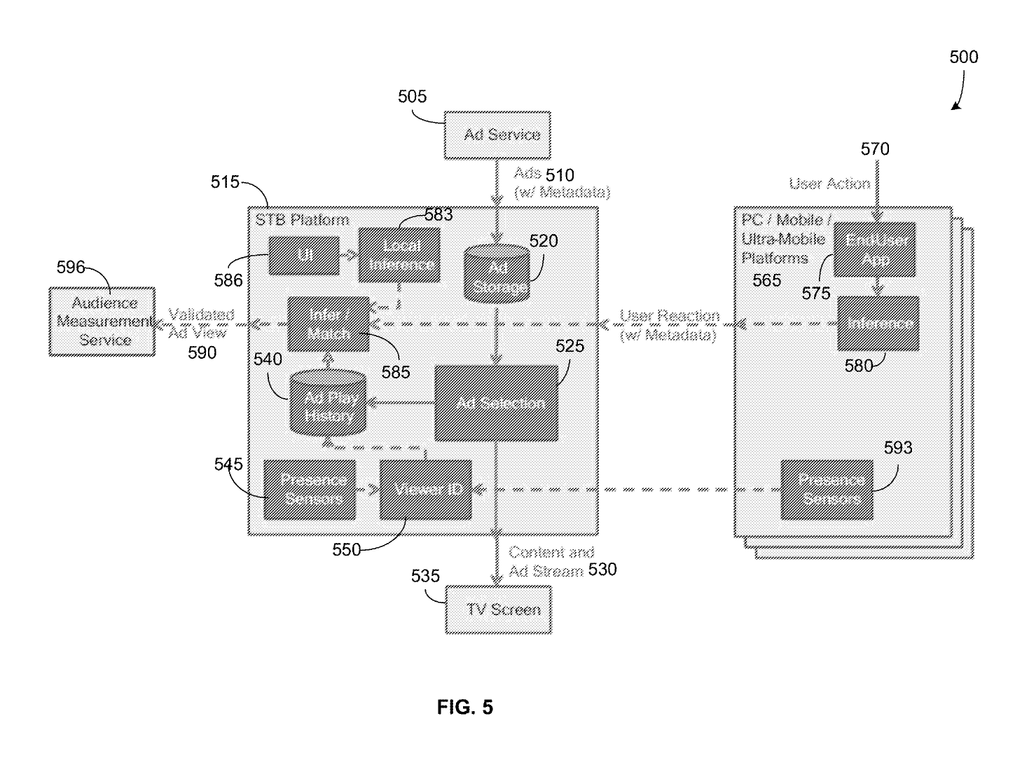

An alternative embodiment is shown in FIG. 5. Here, the inference matching process takes place in the STB, rather than in the viewer's computing platform. An advertising service 505 may provide one or more advertisements 510, including metadata for the each advertisement, to a media platform such as STB 515. In the illustrated embodiment, the advertisements may be stored at an ad storage device 520 in STB 515. Ad storage device 520 may be a hard disk, a flash memory, or any other non-volatile memory device. An ad selection module 525 may be responsible for selection of a particular advertisement for insertion into content. This may result in a content and ad stream 530, which may be eventually displayed to the viewer through a display such as TV screen 535. When the selected advertisement is played for the viewer, the metadata related to the advertisement may be stored at a history data structure, shown here as ad play history 540. Ad play history 540 may be stored in any type of non-volatile memory device, such as a hard disk or flash memory. In an embodiment, ad play history 540 may be stored on the same device as ad storage 520.

In the embodiment shown in FIG. 5, the selected advertisement is sent to the STB 515, where it is combined with a content stream. In such an embodiment, the ad selection logic 525 may choose the advertisement in a manner tailored specifically to the viewer, according to known interests of the viewer, for example. In an alternative embodiment, the advertisement is combined with content before delivery to the STB 515, at which point the entire stream may be shown to the viewer, and the related metadata of the advertisement may be saved to ad play history 540.

Ad play history may also store identification information for the viewer, shown here as viewer ID 550. As in the embodiment of FIG. 4, this information may be needed to determine who, specifically, is viewing the advertisement. With viewer ID 550, it may then be possible to determine the behavior of this viewer, i.e., whether and how he reacts to the advertisement. Viewer ID 550 may be determined in any of several ways. In the illustrated embodiment, one or more presence sensors 545 are shown, which are able to determine viewer ID 550 through biometric means, for example. As discussed above, these sensors may include a microphone to sample the viewer's voice, a camera to acquire a picture of the viewer, or accelerometers in the remote control to detect how the remote is being manipulated. Alternatively, if the viewer is logged in to STB 515 in order to access or utilize his particular preferences or profile, this may be used to determine viewer ID 550. Alternatively, one or more presence sensors 593 in the viewer's computing platform 565 may provide viewer ID 550. Presence sensor 593 may also use biometric technology (such as those described above) or other means to identify the viewer. In this case, viewer ID 550 may be transferred to STB 515 through a wired or wireless data link, using any protocol or networking technology known to persons or ordinary skill in the art.

A user action 570 may be received at the viewer's computing platform 565. Such a platform 465 may be a laptop, a tablet computer, or a smart phone for example and without limitation. User action 570 may be, for example, browsing on the internet, surfing to a particular site, performing a search (e.g., for the product or company name), or making an on-line purchase. Action 570 may be a physical visit to a store that sells the product, or the scanning of the product's bar code by the viewer, using his smart phone. The action 570 may alternatively be telling someone else about the advertised product, through email, text message, or IM, for example. The action 570 may be captured by an end-user application 575. Based on the action 570, information is generated by application 575 and input to potential inference module 580. Potential inference module 580 extracts context data of the user action 570, resulting in a digital codified description of action 570. As noted above, context data may be, for example and without limitation, a web address accessed by the viewer and/or any search terms employed, as captured by application 575. Application 575 may alternatively generate context data such as the address or name of a physical retail store, resulting from a capture of GPS coordinates from a personal communications device, such as a smart phone, or the product's bar code as scanned by the viewer using the smart phone. Context data may also be key words used in a text message, email, or IM sent to another person, as captured by application 575.

The context data generated by potential inference module 580 and advertisement metadata from ad play history 540 may then be sent to inference/matching module 585. In the illustrated embodiment, this information is sent from the viewer's computing platform 565 to the STB 515. This transfer may take place directly, either using short range communications mechanisms when the devices are in physical proximity, or using any networking technology known to persons of ordinary skill in the art. Alternatively, a networked storage service may be employed, where such a service may be embodied as a high-availability entity with which all devices securely share information.

Inference/matching module 585 may then determine if there is a correlation between the advertisement metadata and the output of potential inference module 580. The match criteria may include whether the action 570 was directed towards a product that was the subject of the viewed advertisement, where the product was identified in the advertisement metadata from ad play history 540. As noted above, an action 570 that may meet this criterion may include an Internet search for the product name, a visit to the product's web site or to a retailer site that sells this product, or an on-line purchase of this product, for example. An additional criterion may be that the action 570 had to have happened within a predefined period after viewing the advertisement. Recall that the advertisement metadata from ad play history 540 may include the time of presentation; likewise the context data (potential inference 580) may include the time at which action 570 took place. If the action 570 took place long after the presentation of the advertisement, then the action 570 may not be considered to be a reaction to the advertisement. In an embodiment, this predefined period may be one hour, but may differ for different types of user reactions and for different context data, as described above.

Note that user action 570 may not be an on-line action. The viewer may instead respond to a product advertisement by physically visiting a brick-and-mortar store that sells the product. User action 570 may be such a visit. One way in which such an action may be detected is by taking advantage of the GPS capabilities of the viewer's smart phone. The smart phone (which may be an example of viewer computing platform 565) may detect that it is entering a location that corresponds to a retailer for the advertised product. The end-user application 575 may then receive an indication of this and generate the corresponding input to potential inference module 580.

The module 585 may be embodied in hardware, firmware, software, or any combination thereof.

If a match is found by inference/matching module 585, then the viewing of the advertisement is considered validated. A message 590 reflecting this validation may then be sent anonymously to an audience measuring service 596. A third party anonymization service may be used to preserve the anonymity of individual viewers. In an embodiment, public key protocols may be used in communication with such an anonymization service to assure anonymity. Audience measuring service 596 may tally the number of validations received for the advertisement across a set of viewers, resulting in a final count. In an embodiment, this count may be sold or otherwise offered to the advertiser that produced the ad, to a broadcaster, or to any other interested party.

One or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein. The computer readable medium may be transitory or non-transitory. An example of a transitory computer readable medium may be a digital signal transmitted over a radio frequency or over an electrical conductor, through a local or wide area network, or through a network such as the Internet. An example of a non-transitory computer readable medium may be a compact disk, a flash memory, or other data storage device.

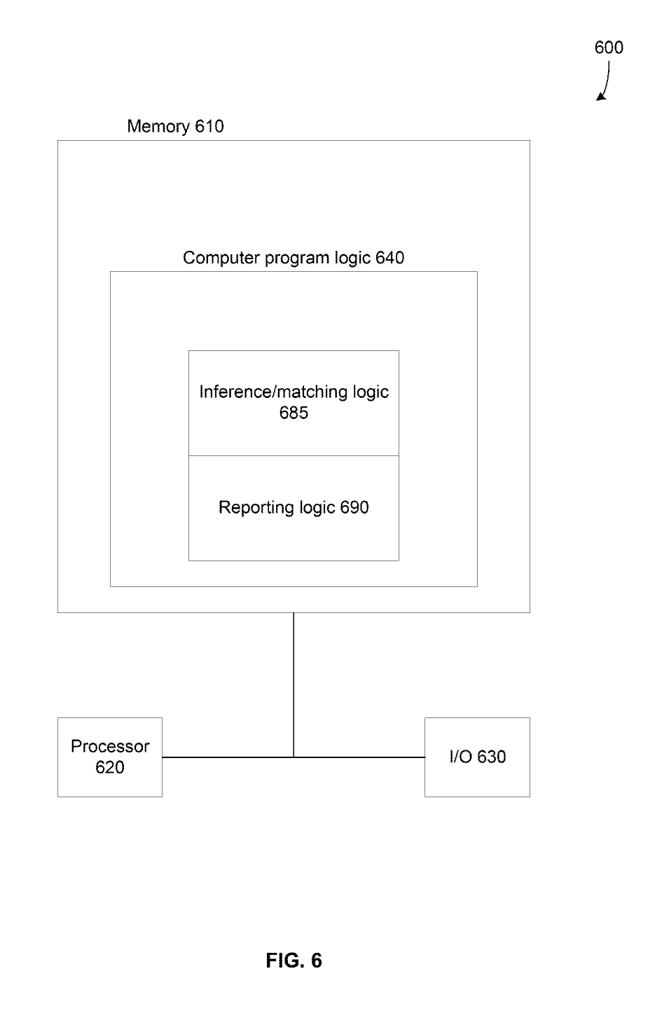

A software or firmware embodiment of the processing described above is illustrated in FIG. 6. System 600 may include a programmable processor 620 and a body of memory 610 that may include one or more computer readable media that store computer program logic 640. Memory 610 may be implemented as one or more of a hard disk and drive, a removable media such as a compact disk and drive, flash memory, or a random access (RAM) or read-only memory (ROM) device, for example. Processor 620 and memory 610 may be in communication using any of several technologies known to one of ordinary skill in the art, such as a bus. Processor 620 may be a special purpose graphics processor or a general purpose processor being used as a graphics processor. Logic contained in memory 610 may be read and executed by processor 620. One or more I/O ports and/or I/O devices, shown collectively as I/O 630, may also be connected to processor 620 and memory 610. In an embodiment such as that of FIG. 4, system 600 may be incorporated in a viewer computing platform 465. In an embodiment such as that of FIG. 5, system 600 may be incorporated into a media platform such as STB 515.

In an embodiment, computer program logic 640 may include the logic modules 685 and 690. Inference/matching logic 685 may be responsible for comparing the metadata of an advertisement with the context data or potential inference that arises from a user action. Inference/matching logic 685 may make a determination as to whether an action by the viewer represents a reaction to the advertisement.

Reporting logic 690 may be responsible for generating and sending a message to an audience measurement service as to the validation of an advertisement. In an embodiment, such a message may be sent anonymously, in a manner that does not reveal the identity of the viewer.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method, comprising:
displaying an advertisement to a consumer via the consumer's television;
capturing context data of a reaction of the consumer to the advertisement, where the reaction suggests interest in a subject of the advertisement, the context comprises one or more of a time, place, and means of the reaction;
matching the context data with the advertisement;
recording an extent of reaction to the advertisement, without identifying any individual consumers; and
reporting the extent of reaction to an audience measurement service.

2. The method of claim 1, wherein
the reaction comprises browsing online for the subject of the advertisement, and the context data comprises the time at which the browsing took place and the product, service, or company targeted by the browsing.

3. The method of claim 1, wherein
the reaction comprises online purchasing of the subject of the advertisement, and
the context data comprises the time at which the purchase took place, and the product or service purchased.

4. The method of claim 1, wherein
the reaction comprises one of
visiting a physical store that sells the subject of the advertisement,
scanning a barcode on a product that is the subject of the advertisement, or purchasing the product, and
the context data comprises the time and physical location at which the visit took place, and the product targeted by the visit.

5. The method of claim 1, wherein
the reaction comprises sending an electronic message regarding the product or service to another person, and
the context data comprises the time at which the electronic message is sent.

6. The method of claim 1, wherein the matching comprises determining whether the reaction took place within a predefined time interval after the display of the advertisement.

7. A computer program product including a non-transitory computer readable medium having computer program logic stored therein, the computer program logic comprising:
logic to cause a processor to store context data of a reaction of a consumer to a television advertisement, where the reaction suggests interest in a subject of the advertisement, the context comprises one or more of a time, place, and means of the reaction; and
logic to cause a processor to match the context data with the advertisement.

8. The computer program product of claim 7, wherein
the reaction comprises browsing online for the subject of the advertisement, and
the context data comprises the time at which the browsing took place and the product, service, or company targeted by the browsing.

9. The computer program product of claim 7, wherein
the reaction comprises online purchasing of the subject of the advertisement, and
the context data comprises the time at which the purchase took place, and the product or service purchased.

10. The computer program product of claim 7, wherein
the reaction comprises one of
visiting a physical store that sells the subject of the advertisement,
scanning a barcode on a product that is the subject of the advertisement, or
purchasing the product, visiting a physical store for the subject of the advertisement, and
the context data comprises the time and physical location at which the visit took place, and the product targeted by the visit.

11. The computer program product of claim 7, wherein
the reaction comprises sending an electronic message regarding the product or service to another person, and
the context data comprises the time at which the electronic message is sent.

12. The computer program product of claim 7, wherein the matching comprises determining whether the reaction took place within a predefined time interval after the display of the advertisement.

13. A system, comprising:
a processor; and
a memory in communication with said processor, wherein said memory stores a plurality of processing instructions configured to direct said processor to
store context data of a reaction of a consumer to an advertisement, where the reaction suggests interest in a subject of the advertisement, the context data comprises one or more of a time, place, and means of the reaction;
matching the context data with the advertisement.

14. The system of claim 13, wherein the reaction comprises browsing online for the subject of the advertisement, and
the context data comprises the time at which the browsing took place and the product, service, or company targeted by the browsing.

15. The system of claim 13, wherein
the reaction comprises online purchasing of the subject of the advertisement, and
the context data comprises the time at which the purchase took place, and the product, or service purchased.

16. The system of claim 13, wherein
the reaction comprises one of
visiting a physical store that sells the subject of the advertisement,
scanning a barcode on a product that is the subject of the advertisement, or
purchasing the product, visiting in a physical store for the subject of the advertisement, and
the context data comprises the time and physical location at which the visit took place, and the product targeted by the browsing.

17. The system of claim 13, wherein
the reaction comprises sending an electronic message regarding the product or service to another person, and
the context data comprises the time at which the electronic message is sent.

18. The system of claim 13, wherein the matching comprises determining whether the reaction took place within a predefined time interval after the display of the advertisement.

19. The system of claim 13, wherein said memory and said processor are located in a personal computing platform.

20. The system of claim 13, wherein said memory and said processor are located in a media platform.
